(19) United States
(12) Patent Application Publication
(10) Pub. No.: US 2004/0219244 A1
(43) Pub. Date: Nov. 4, 2004

(54) Method and device for producing fiber-reinforced components by an injection method

(76) Inventors: Jurgen Filsinger, Ohringen (DE); Thomas Lippert, Augsburg (DE); Franz Stadler, Bohmfeld (DE); Stefan Utecht, Kaufering (DE)

Correspondence Address: GREENBLUM & BERNSTEIN, P.L.C., 1950 ROLAND CLARKE PLACE, RESTON, VA, 20191, US

(21) Appl. No.: 10/487,254

(22) PCT Filed: Aug. 2, 2002
(86) PCT No.: PCT/DE02/02857

(30) Foreign Application Priority Data
Aug. 22, 2001 (DE) 101-40-166.3

(51) Int. Cl. B29C 51/10

(52) U.S. Cl. 425/116; 425/127; 425/388

(57) ABSTRACT

Method for producing a fiber-reinforced plastic component including arranging a fiber composite semi-finished product on a tool, forming a first cavity, forming a second cavity adjacent to the first cavity, suctioning air from the second cavity, distributing the matrix material over the at least one side using a flow promoting device, and allowing the matrix material to penetration into the fiber composite semi-finished product from a vertical direction. This Abstract is not intended to define the invention disclosed in the specification, nor intended to limit the scope of the invention in any way.

### CROSS-REFERENCE TO RELATED APPLICATIONS

The instant application is a National Stage Application of International Application No. PCT/DE02/02857 filed on Aug. 2, 2002 and published as International Publication WO 03/018297 on Mar. 6, 2003. The instant application also claims priority under 35 U.S.C. §119 of German Application No. 101 40 166.3 filed on Aug. 22, 2001.

### BACKGROUND OF THE INVENTION

1. Field of the invention

The invention relates to a method for producing fiber-reinforced plastic components of dry fiber composite semi-finished products by way of an injection method and a subsequent hardening and a device for carrying out the method.

2. Description of the prior art

Such a method is known from printed patent specification DE 100 13 409 C1, in which a fiber composite semi-finished product is installed on a tool and is covered by means of a gas-permeable membrane impermeable to matrix material in order to form a first cavity, whereby a flow-promoting device is arranged between the semi-finished product and the membrane. A second cavity is arranged adjacent to the first cavity, which second cavity is delimited from the surroundings by means of a gas- and matrix-material-impermeable film sealed with respect to the tool. By suctioning off the air from the second cavity, the matrix material is suctioned from the reservoir into the evacuated first cavity, and the flow-promoting device causes a distribution of the matrix material over the surface of the semi-finished product facing it and a penetration of the same into the semi-finished product vertically.

### SUMMARY OF THE INVENTION

The invention aims to develop the method further such that the method safety and the quality of the component to be produced are increased.

The invention also renders possible a greater diversity of technical properties of the components to be produced.

The invention also provides for a method for producing a fiber-reinforced plastic component, wherein the method comprises arranging a fiber composite semi-finished product on a tool, forming a first cavity, wherein the first cavity is defined by at least one side of the fiber composite semi-finished product and a gas-permeable membrane which is impermeable to a matrix material, forming a second cavity adjacent to the first cavity, wherein the second cavity is delimited from a surrounding area by a film that is gas-impermeable and matrix-material-impermeable and that is sealed with respect to the tool, suctioning air from the second cavity, wherein the suctioning causes evacuation of the first cavity and causes the matrix material to be suctioned from a reservoir and into the first cavity, during the suctioning, subjecting a flow of the matrix material into the first cavity to at least a temporary increase in pressure using a pressure control system, distributing the matrix material over the at least one side using a flow promoting device, and allowing the matrix material to penetration into the fiber composite semi-finished product from a vertical direction.

The fiber composite semi-finished product may comprise a dry fiber composite semi-finished product and the first cavity may be formed around the at least one side of the fiber composite semi-finished product.

The method may further comprise controlling a matrix material pressure based on at least one of a viscosity of the matrix material, a temperature of the matrix material, and a pressure in the first cavity.

The method may further comprise controlling a pressure of the flow based on at least one of a viscosity of the matrix material, a temperature of the matrix material, and a pressure in the first cavity.

The method may further comprise controlling a pressure of the flow based on a temperature of the matrix material flowing into the first cavity.

The method may further comprise controlling a pressure of the flow based on a temperature in the first cavity.

The invention also provides for a method for producing a fiber-reinforced plastic component, wherein the method comprises arranging a fiber composite semi-finished product on a tool, forming a first cavity, wherein the first cavity is defined by at least one side of the fiber composite semi-finished product and a gas-permeable membrane which is impermeable to a matrix material, forming a second cavity adjacent to the first cavity, wherein the second cavity is delimited from a surrounding area by a film that is gas-impermeable and matrix-material-impermeable and that is sealed with respect to the tool, suctioning air from the second cavity, wherein the suctioning causes evacuation of the first cavity and causes the matrix material to be suctioned from a reservoir and into the first cavity via line, during the suctioning, providing at least a temporary vacuum in the line using a pressure control system, distributing the matrix material over the at least one side using a flow promoting device, and allowing the matrix material to penetration into the fiber composite semi-finished product from a vertical direction.

The fiber composite semi-finished product may comprise a dry fiber composite semi-finished product and the first cavity may be formed around the at least one side of the fiber composite semi-finished product.

The invention also provides for a device for producing a fiber-reinforced plastic component by an injection process, wherein the device comprises a tool adapted to support a fiber composite semi-finished product. A first membrane is gas-permeable and impermeable to a matrix material. The first membrane is structured and arranged to form a first cavity with at least one side of the fiber composite semi-finished product. A line allows insertion of the matrix material into the first cavity. A second membrane is impermeable to gas and to the matrix material. The second membrane is sealed with respect to the tool and is structured and arranged to form a second cavity adjacent to the first cavity. The second cavity is delimited from a surrounding area via the second membrane. A pressure control system is connected to the line and influences a pressure in the line. When air is suctioned from the second cavity, the first cavity is evacuated, the matrix material is suctioned from a reservoir into the first cavity, and the matrix material penetrates vertically into the fiber composite semi-finished product.

The fiber composite semi-finished product may comprise a dry fiber composite semi-finished product and the first cavity may be formed around the at least one side of the fiber composite semi-finished product.

The invention also provides for a method for producing a fiber-reinforced plastic component, wherein the method comprises arranging a fiber composite semi-finished product on a tool, forming a first cavity, wherein the first cavity is defined by a gas-permeable membrane which is impermeable to a matrix material, forming a second cavity adjacent to the first cavity, wherein the second cavity is delimited from a surrounding area by a film that is gas-impermeable and matrix-material-impermeable and that is sealed with respect to the tool, suctioning air from the second cavity, wherein the suctioning causes evacuation of the first cavity and causes the matrix material to be suctioned from a reservoir and into the first cavity, distributing the matrix material over at least one side of the fiber composite semi-finished product using at least one flow promoting device arranged on the at least one side, and allowing the matrix material to penetration into the fiber composite semi-finished product from a vertical direction.

The at least one side of the fiber composite semi-finished product may face the tool and the first cavity may be formed around the at least one side of the fiber composite semi-finished product. The at least one flow promoting device may be arranged between the at least one side and the tool.

The method may further comprise distributing the matrix material over an opposite side of the fiber composite semi-finished product using at least one other flow promoting device arranged on the opposite side.

The method may further comprise, during the suctioning, subjecting a flow of the matrix material into the first cavity to at least a temporary increase in pressure using a pressure-producing system.

The invention also provides for a device for producing a fiber-reinforced plastic component by an injection process, wherein the device comprises a tool adapted to support a fiber composite semi-finished product. At least one flow-promotion device is configured to be arranged on a surface of the fiber composite semi-finished product which faces the tool. A first membrane is gas-permeable and impermeable to a matrix material. The first membrane is structured and arranged to form a first cavity with at least one side of the fiber composite semi-finished product. A line allows insertion of the matrix material into the first cavity. A second membrane is impermeable to gas and to the matrix material. The second membrane is sealed with respect to the tool and is structured and arranged to form a second cavity adjacent to the first cavity. The second cavity is delimited from a surrounding area via the second membrane. When air is suctioned from the second cavity, the first cavity is evacuated, the matrix material is suctioned from a reservoir into the first cavity and into the at least one flow-promotion device, and the matrix material is distributed over the surface and penetrates vertically into the fiber composite semi-finished product.

The fiber composite semi-finished product may comprise a dry fiber composite semi-finished product and the first cavity may be formed around the at least one side of the fiber composite semi-finished product.

The invention also provides for a method for producing a fiber-reinforced plastic component, wherein the method comprises arranging a fiber composite semi-finished product on a tool, applying a layer on at least one surface of the fiber composite semi-finished product on a tool, wherein the layer comprises one of a metallic layer and a composite layer, forming a first cavity, wherein the first cavity is defined by a gas-permeable membrane which is impermeable to a matrix material, forming a second cavity adjacent to the first cavity, wherein the second cavity is delimited from a surrounding area by a film that is gas-impermeable and matrix-material-impermeable and that is sealed with respect to the tool, suctioning air from the second cavity, wherein the suctioning causes evacuation of the first cavity and causes the matrix material to be suctioned from a reservoir and into the first cavity, and allowing the matrix material to penetration through the layer and into the fiber composite semi-finished product, wherein the allowing connects the layer to the fiber composite semi-finished product.

The first cavity may be formed around the at least one side of the fiber composite semi-finished product. The allowing may comprise allowing the matrix material to penetration through the layer and vertically into the fiber composite semi-finished product.

The invention also provides for a device for producing a fiber-reinforced plastic component by an injection process, wherein the device comprises a tool adapted to support a fiber composite semi-finished product. At least one flow-promotion device is configured to be arranged on at least one surface of the fiber composite semi-finished product. A layer is arranged on at least one surface of the fiber composite semi-finished product on a tool. The layer comprises one of a metallic layer and a composite layer. A membrane is gas-permeable and impermeable to a matrix material. The membrane is structured and arranged to form a first cavity with at least one side of the fiber composite semi-finished product. A line allows insertion of the matrix material into the first cavity. A film is impermeable to gas and to the matrix material. The film is sealed with respect to the tool and is structured and arranged to form a second cavity adjacent to the first cavity. The second cavity is delimited from a surrounding area via the film. When air is suctioned from the second cavity, the first cavity is evacuated, the matrix material is suctioned from a reservoir into the first cavity, into the at least one flow-promotion device and through the layer, the matrix material penetrates vertically into the fiber composite semi-finished product, and the layer is connected to the fiber composite semi-finished product.

The fiber composite semi-finished product may comprise a dry fiber composite semi-finished product and the first cavity may be formed around the at least one side of the fiber composite semi-finished product. The at least one flow-promoting device may be configured to cause a distribution of the matrix material over the at least one surface.

The invention also provides for a method for producing a fiber-reinforced plastic component, wherein the method comprises arranging a fiber composite semi-finished product on a tool, forming a first cavity, wherein the first cavity is defined by a gas-permeable membrane which is impermeable to a matrix material, forming a second cavity adjacent to the first cavity, wherein the second cavity is delimited from a surrounding area by a film that is gas-impermeable and matrix-material-impermeable and that is sealed with respect to the tool, suctioning air from the second cavity, wherein the suctioning causes evacuation of the first cavity and causes the matrix material to be suctioned from a reservoir and into the first cavity, and controlling vacuum, temperature and pressure of the first cavity in order to harden the fiber composite semi-finished product.

### BRIEF DESCRIPTION OF THE DRAWINGS

The invention is described below on the basis of the attached figures. They show:

FIG. 1 shows a section through a first embodiment of the device according to the invention in a diagrammatic representation, with which device a first method according to the invention can be carried out;

FIG. 2 shows a section through a second embodiment of the device according to the invention in diagrammatic representation, with which device another method according to the invention can be carried out;

FIG. 3 shows a section through a third embodiment of the device according to the invention in diagrammatic representation, with which device another method according to the invention can be carried out; and

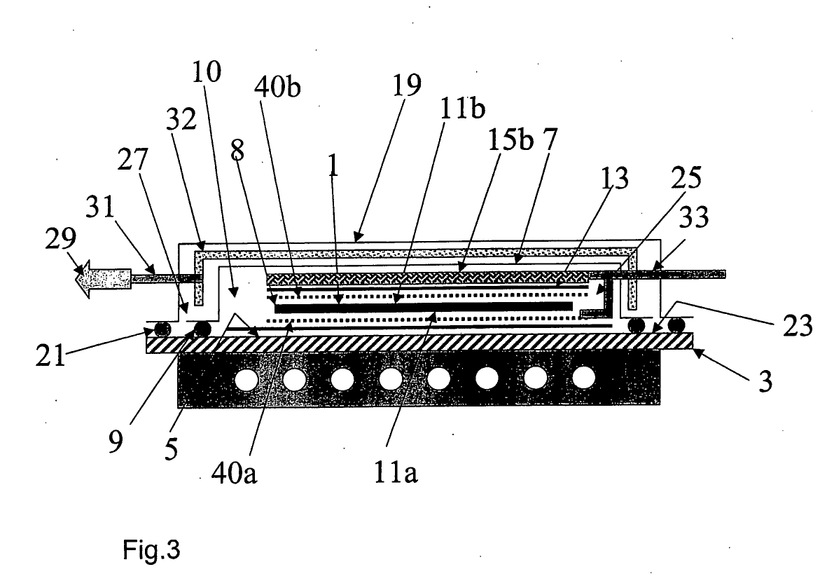

FIG. 4 illustrates the temperature and the vacuum in a first cavity around the semi-finished product and the autoclave pressure respectively over time typical for another method according to the invention.

### DETAILED DESCRIPTION OF THE PRESENT INVENTION

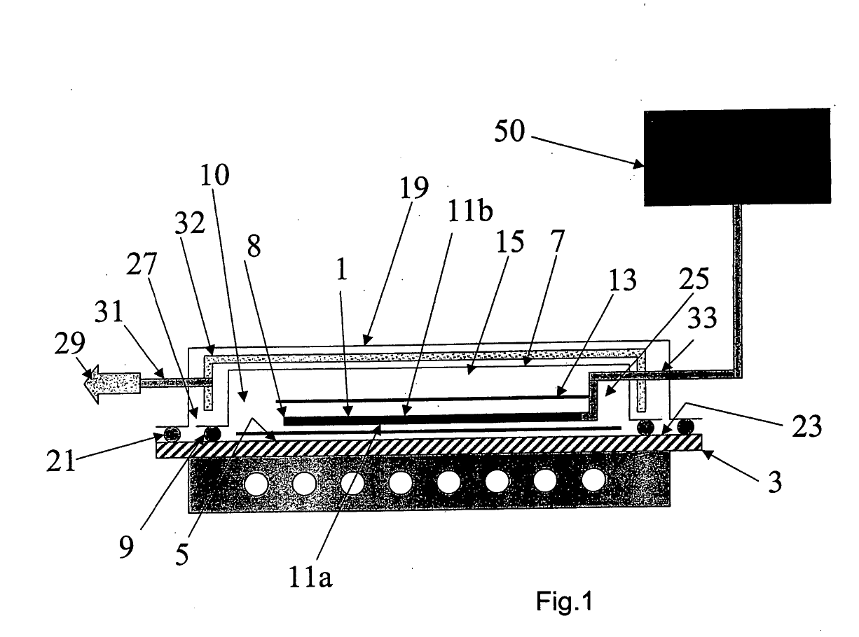

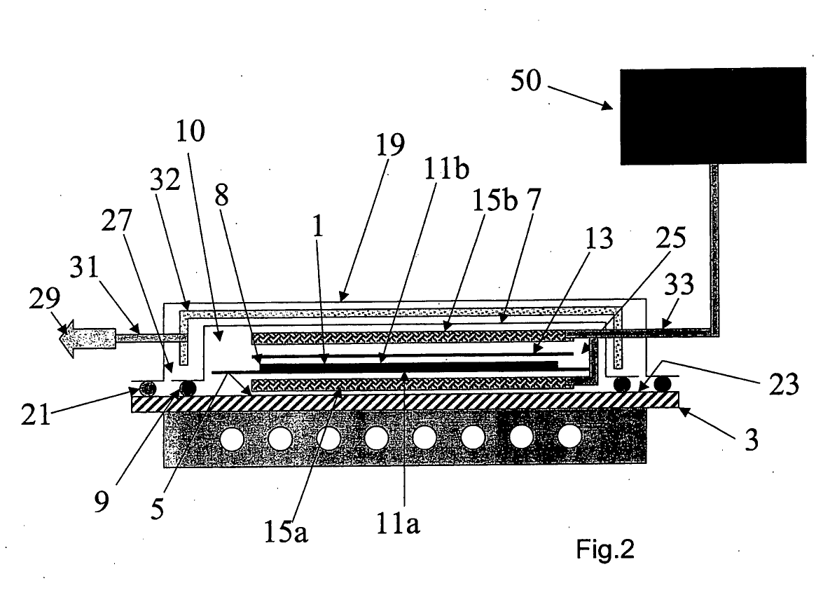

The devices shown in FIGS. 1 and 2 as embodiments of the invention show the component to be produced or dry fiber composite semi-finished products 1, which is or are arranged on a tool 3, e.g., by way of a structure surface 5. The component or laminate can thereby be a plastic component of carbon fibers, glass fibers, aramid fibers, boron fibers or hybrid materials, with developable, not developable or not completely developable geometry, and can be used in particular for the production of non-reinforced and reinforced large-surface planking fields, plastic tools or joint repairs of damaged fiber composite components. The reinforcement can thereby represent a so-called integral reinforcement (profiles of carbon fibers, etc., profiles as combination of sandwich and carbon fiber, etc.) or a typical areal sandwich structure. The tool 3 features a suitable shape to accept the component 1 or, if necessary, the structure surface 5 and can be made of different suitable materials, e.g., wood, steel, sheet metal, glass and the like.

The component 1 is covered with a semi-permeable membrane 7 that is gas-permeable, but prevents the matrix material from passing through. However, the membrane 7 is sealed as tightly as possible to the component 1 outside the circumferential surface 8 by way of a seal 9 that serves to seal the inner or first cavity formed by the membrane 7 and the surface 5 or the tool surface 3. Alternatively, the membrane 7 can also be guided around the entire component. This can take place with the seal 9 or without the same by embodying the membrane 7 in one piece. A release fabric 13 (optional) and a flow-promoting device 15a, 15b (FIG. 2) can be arranged between the component 1 and the membrane 7 over the entire surface 11 of the component 1 facing the membrane 7, which flow-promoting device has the function of dispersing the matrix material and keeping the membrane 7 at a distance from the surface 11 of the component 1. The flow-promoting device 15 can be a type of screen or lattice or also a stiff woven or knitted fabric or mesh that cannot be greatly compacted in a vacuum and is made, e.g., of the materials metal, plastics or textile semi-finished products.

The arrangement of the structure surface 5, the component 1, the membrane 7 with the seal 9 and, if necessary, with the release fabric 13 and the flow-promoting device 15a, 15b being covered with a film 19 that is gas-impermeable. This is sealed around the circumference of the membrane 7 with a seal 21 to the tool 3 so that the second cavity or outer cavity 27 formed by the surface 23 of the tool 3 and the inner wall of the film 19 is sealed off from the surroundings. A ventilation fabric 32 can be inserted between the film 19 and the membrane 7, which fabric, e.g., can be a glass fabric or a non-woven fabric or the like. If necessary, this ventilation fabric 32 has the function of conducting the air and gases that have been suctioned through the membrane out of the second cavity 27 in the interior cavity 10/25 along the membrane surface for suctioning by a vacuum pump 29 (not shown). This second cavity 27 can be evacuated by way of the vacuum pump 29 and a corresponding gas line 31 leading into the cavity 27. Moreover, a second line 33 runs into the interior cavity 10, through which line matrix material, and in particular resin, can be inserted into the interior cavity 10.

To insert matrix material into the component 1, hoses or lines 33 that are connected to a resin reservoir (not shown) lead into a cavity 25 located in the first cavity 10. By evacuating the second cavity 27, a vacuum is produced in the first cavity 10, which causes the insertion of matrix material into the first cavity 10 via the line 33.

The tool and the reservoir for the matrix material stand respectively either on heating plates, inside a heat chamber, within a heatable liquid (oil bath or the like) or inside an adjustable furnace, if the selected resin system requires a thermal treatment during the injection.

In one embodiment of the device according to the invention or the method according to the invention, a pressure control system 50 is provided which can at least temporarily influence or regulate the pressure or also the vacuum inside the line 33 or the reservoir for the matrix material to be fed thereby, in order to control the insertion of the matrix material. The pressure control system 50 is connected to the line 33 in order to influence the pressure in the line 33. If the pressure in the line 33 is increased, the insertion of the matrix material can thereby be accelerated, in particular, temporarily. A pressure equalization can be achieved in the first cavity 10 by producing a vacuum in the reservoir of the matrix material. The production of a vacuum in the reservoir takes place preferably towards the end of the injection phase, or not until after the injection phase, in order to thus remove an improved withdrawal of air from the semi-finished product that has absorbed matrix material. A vacuum pump, hydraulic pump or pneumatic pump, a hose pump, compressed air or similar technological arrangements are possible as a pressure control system 50. The pressure control system 50 can be provided only to produce the vacuum or only to produce the pressure or to fulfill both functions. In the latter case the vacuum and the pressure production can be realized through one and the same device or two different devices.

Through the use of the pressure control system, the use of a flow-promoting device 15b can be dispensed with. Also the quality of the component 1 to be produced can be influenced through the control or regulation of the vacuum and the pressure in the line or the reservoir. The increase of the pressure of the matrix material can thereby be controlled on the basis of the viscosity of the matrix material, a temperature and/or the pressure in the first cavity 10. The temperature of the matrix material flowing in, or the temperature in the first cavity 10, can be used as the temperature.

In an embodiment of the invention, a layer of a flow-promoting device 15a is provided between the semi-finished product 1 and the tool 3. This flow-promoting device can also be provided without the use of the pressure-producing system 50. Through the use of the flow-promoting device 15a between the semi-finished product 1 and the tool 3, air pockets are avoided on the lower side 1 la of the semi-finished product facing the tool 3 when the matrix material flows in. This increases the process safety. With this embodiment of the invention the additional use of the pressure-producing system 50 can be advantageous in particular for process control.

In addition to the use of the first flow-promoting device 15a between the semi-finished product 1 and the tool 3, a second flow-promoting device 15b can also be arranged on the upper side 11b of the semi-finished product facing away from the tool 3. The second flow-promoting-device 15b on the side 11b of the semi-finished product facing away from the tool 3 takes on the function of a flow channel. The flow-promoting device 15b thereby features a minimum thickness below the vacuum structure of the film 19 in order to render possible this flow. It is thus a spacer that forms a flow channel between the membrane 7 and the component 1.

The flow-promoting devices 15a, 15b have the function of rendering possible the distribution of the matrix material reaching the cavity 10/25 through the matrix feed line 33 on the component surface. The flow-promoting device 15a, 15bcan be a mesh, a woven fabric, a knitted fabric or the like which features a coarse-meshed structure if possible in order to produce a low flow resistance. Any materials of, e.g., metal or plastic or the like can be used as material, provided the common minimum requirements (temperature and media stability) given above are met. The matrix feed line 33 can be guided as far as desired into the first cavity 10 to support the matrix transport. A branching or several feed lines are permissible. This matrix feed line 33 can feature openings inside the first cavity 10, which openings represent, e.g., holes, crosswise slits, lengthwise slits or the like. This supports the resin transport into the flow-promoting device.

A joint resistance to the matrix systems used during the process duration and a resistance with respect to temperatures occurring during the process are required of the film 19, of the release fabric 13, of the membrane 7, of the ventilation fabric 32 and of the flow-promoting devices 15a, 15b. According to the geometry to be depicted, a deposit must be possible in this geometry through expansion, folding, or the like.

In another embodiment of the invention, a metallic or ceramic layer 40a, 40b is applied at least on one surface 11a, 11b of the semi-finished product, whereby by suctioning air from the second cavity 27, a penetration of the matrix material through the layer 40a, 40b, and a penetration of the same vertically into the semi-finished product 1 occurs to connect to the semi-finished product 1. The metallic or ceramic layer (mesh) 40a, 40b can be formed as woven fabric, mesh or knitted fabric. In particular copper, bronze or high-grade steel are possible as metallic materials.

The layer 40a, 40b is provided so that it connects to the semi-finished product under the influence of the matrix material flowing in, in order to influence the material properties of the semi-finished product. For example, the lightning-conductor property of the component to be produced can be achieved and influenced through the use of a copper or bronze mesh. The properties of the component to be produced can be improved through the use of ceramic layers 40a, 40b. The use of high-grade steel layers 40a, 40b renders possible the improvement of erosion properties of the component to be produced. According to the invention, a combination of the materials mentioned can also be used. When using a layer 40a, 40b, in addition, a flow-promoting device 15a, 15b can be arranged on at least one surface 11a, 11b of the layer, thus on the surface facing the tool or on the surface lying opposite to this, in order to cause a distribution of the matrix material over these surfaces 11a, 11b and a penetration of the same into the semi-finished product 1.

The film 19 is a vacuum membrane according to the prior art, which membrane is gas-impermeable and has the above-listed features. Its function is to seal the second cavity 27 from the surroundings. Films or rubber membranes are possible as typical materials for this. Examples of a 180° C. (350° F.) application would be, e.g., films on the basis of PTFE, FEP or the like. Other materials are possible depending on the selected matrix system and its specific hardening temperatures while observing the requirement described above.

The function of the release fabric 13, also called Peel Ply in the literature, is that after the process has been carried out, the flow-promoting device 15 filled with matrix material can be more easily peeled off (releasing=release fabric), i.e. separated from the component 1, since all auxiliary substances listed serve only as auxiliary arrangements for producing the component 1. The release fabric 13 is designed so that it does not form a permanent connection to the matrix material and the component surface. This is achieved through the surface structure of the release material and/or through additional non-stick coatings (such as, e.g., PTFE, silicone or the like). Glass fabric, nylon fabric or the like can be listed as typical materials. The release fabric must be gas-permeable and likewise permeable for the matrix material in both directions.

The membrane 7 is a semi-permeable membrane of, e.g., technical plastic material, which is oriented to the process conditions regarding temperature stability and media stability. Furthermore, this membrane is permeable for gases, but it is not permeable for liquids with viscosities comparable to water or higher viscosity. This behavior is achieved by gas-permeable pores located in the membrane, which pores are distributed over the membrane surface in a more or less large-surface manner. The size of the pores is selected so that the matrix system cannot penetrate. The thickness of the membrane is in the tenth of a millimeter range. An adequate flexibility for draping and shaping is present through the use of typical plastic material.

The ventilator fabric 32 above the flow-promoting device 15 has the function of guiding the air suctioned through the membrane and other volatile constituents for suctioning to the vacuum pump 29. This material can be of any material, provided it is sufficiently temperature- and media-stable regarding the materials necessary in the process and an air line is possible in the lengthwise direction. Fleecy mats, woven fabrics, knitted fabrics, meshes, etc. are used for this which can be of metal, plastic or the like materials.

The devices according to the invention can be used for virtually any shapes of components. For example, the semi-finished products can feature hat sections with or without a foam core or a core with a closed surface formed with any other materials. In particular, semi-finished products or components in sandwich or honeycomb forms are possible.

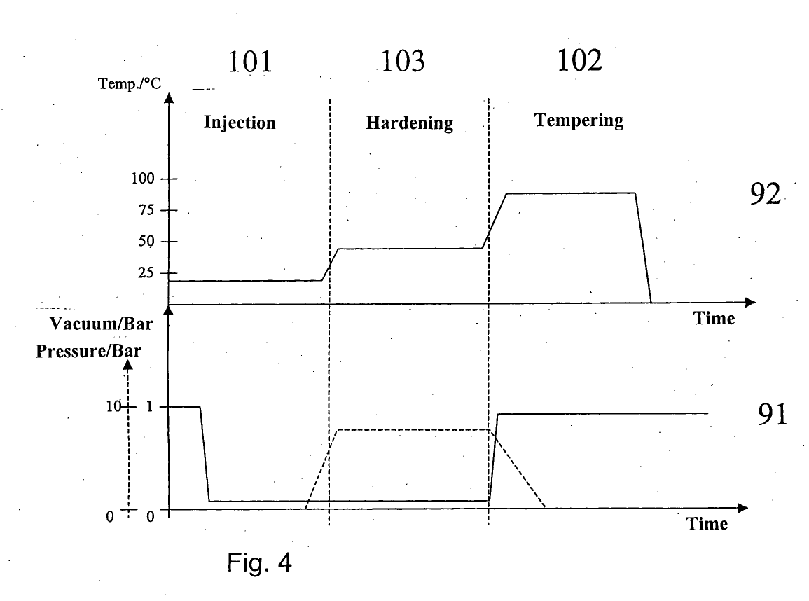

FIG. 4 shows by way of example typical courses for the vacuum 91 and temperature 92 prevailing in the first cavity 10. Furthermore, FIG. 4, shows by way of example, the course of the pressure for the autoclaves used in another embodiment of the invention.

In detail the temperature and vacuum courses are divided into at least two phases, the injection phase 101 and the hardening phase 103. Another tempering phase 102 can be provided after these phases. The temperature is lower in the injection phase 101 than in the hardening phase 103.

The temperature course and the vacuum control are provided such that an optimum quality, few to no pores, and a suitable fiber volume percent are achieved with the hardened component. The specifications for the temperature result from the material requirements of the matrix material. Regardless of the selected matrix material, the vacuum can be kept at a constant level throughout the entire process up to hardening, i.e., the state in which the matrix material has changed its state of aggregation from liquid into irreversibly solid. Usual values and tolerances that are to be adhered to hereby are, e.g., 1 to 10 mbar (absolute pressure, close to the ideal vacuum). After the hardening 103, a vacuum is no longer necessary. The necessary temperature courses are characterized as follows: During the injection phase 101 at a full vacuum, a temperature is necessary which is determined through the viscosity curve of the matrix material. The temperature is selected such that the matrix material is sufficiently liquid to reach the interior cavity 10/25 through the feed line 33 by way of vacuum suction. This is the minimum temperature that is necessary for the process. At the same time this temperature must not be selected to be so high that a hardening (loss of viscosity, solid state of the matrix) is reached. The process temperature is therefore set (depending on the selected matrix material) so that an injection is possible (low viscosity) and the remaining time until hardening is sufficient for the injection, i.e. the almost complete filling of the interior cavity 10/25 with matrix material (technical term, e.g., gel time). Typical necessary viscosities during the injection phase are hereby, e.g., ranges from 1 to 1000 mPas. Typical temperatures with a 350° F. (180° C.) system are, e.g., 70 to 120° C. for the injection phase 101, approx. 100 to 180° C. for the hardening phase 103 and for the tempering phase 102 values from approx. 160 to 210° C.

For selected matrix materials, e.g., RT matrix materials, the variant injection 101 temperature is advantageously identical to the hardening 103 temperature and is advantageously identical to the tempering 102 temperature.

The vacuum is formed before the injection phase 101 (FIG. 4) or before the same. In the method according to the invention, a vacuum of typically 1 to 10 mbar is produced for the injection, which vacuum extends until the end of the hardening phase and should not be reduced.

The various embodiments of the method according to the invention can be further supplemented by an autoclave with which the first cavity 10 is acted on by vacuum, pressure and temperature in a time-dependent manner during or after the injection phase in controlled or regulated manner. The fiber volume percent of the component to be produced can thus be increased, residual air remaining in the semi-finished product removed and the shaping of the component to be produced improved.

The method according to the invention is described below:

Dry materials (e.g., carbon fiber-reinforced plastic non-woven fabric, woven fabric etc.) are positioned in a hardening tool of any kind according to constructional specifications and a laminate structure is thus formed from the semi-finished product individual layers. The tool is prepared for release, i.e., pretreated by way of a release compound or release film and release fabric (together it forms the structure surface 5 on the component 1 underside), in order to prevent the matrix material from sticking to the tool and to make it possible to remove the component (unmolding) from the tool surface again. The dry material of the component 1 is preferably provided with the release fabric 13. In addition, a so-called flow-promoting device 15a, 15b can be applied on the side 11a of the semi-finished product facing the tool and/or on the side 11b of the semi-finished product facing the first cavity 10 by simple placement. Another layer 40a, 40b can also be provided on at least one side of the semi-finished product, with or without the use of a flow-promoting device 15a, 15b, in order to improve the component properties. The membrane 7, permeable only for air but not for liquids, is applied on these layers 40a, 40b or the flow-promoting device 15a, 15b, and sealed by way of a seal 9. Subsequently the ventilation fabric 32 is laid over the membrane 7 and sealed from the surroundings by way of a film 19 and a seal 21. The matrix feed line 33 and the vacuum line 29 are inserted during this process with commercial ducts and seals in accordance with FIG. 1. If necessary, the pressure-producing system 50 is connected.

After the application of the materials mentioned and the film or vacuum film 19, the first cavity 10 is evacuated by way of the vacuum pump. At the same time a matrix material reservoir is connected to the system, in order to feed matrix material into the first cavity 10. Through the vacuum, a pressure drop occurs which suctions the matrix material out of the reservoir into the evacuated first cavity 10/25. The matrix material is now distributed on the component surface more or less unhindered and virtually independent of its viscosity characteristic, if necessary, through the flow-promoting device 15 and the feed line 33. If necessary, the inflow of the matrix material is influenced by the pressure-producing system 50. Air that is present is thereby removed through the permanent suctioning of the cavity 27 through the membrane 7. A flowing of the matrix material within the laminate structure, which is characterized by a great flow resistance, does not thereby occur. Instead, the infiltration of matrix material from the component surface occurs vertically downwards into the laminate. The maximum flow path at each point of the component is thus directly a function of the component thickness at this point. The flow resistance is thus very low and consequently resin systems can also be used which were not capable of infiltration in the past due to their viscosity and components with large dimensions can be produced.

The membrane 7 serves to avoid local air cushions. If, e.g., a closing of the flow fronts forming and thus the development of a closed air cushion in the component 1 of the cavity 10/25 occurs without connection to the vacuum outlet of the air, no resin can flow into this air cushion. A defect would occur (no saturation). The air-permeable membrane 7 prevents this effect, since at every point of the component 1 air can always reach perpendicular to the surface through the membrane 7 into a cavity of the vacuum structure 27 that is resin-free and that can be ventilated, and there is suctioned off above the membrane 7 through the vacuum connection 29 with the aid of the ventilation fabric 32. The membrane 7 is not permeable for the resin. A monitoring of the flow fronts is therefore unnecessary, since the process of saturation regulates itself. The degree of saturation is a direct function of the inserted amount of resin which is made available to the process and of the inserted amount of fiber.

As soon as the complete saturation has been completed, the hardening is carried out through a suitable temperature while maintaining the same vacuum. The bubbles (matrix boiling, volatile components, etc.) occurring hereby through the chemical process would lead to pore formation in the finished component with the known processes. This is now prevented through the membrane 7, since a permanent ventilation occurs perpendicular to the surface of the component 1 through the membrane 7.

After completion of the hardening, the component 1 can be unmolded. This means that all process auxiliary materials are removed again from component 1, e.g., by peeling by hand and the component can be removed from the tool 3. This hard component now unmolded with semi-finished products saturated by matrix, depending on the requirement profile, can now be subjected to a purely thermal aftertreatment (tempering in step 102). The tempering can also occur before the unmolding, but need not be carried out to reduce the tool occupation times.

The maximum size of the components that can be produced by the method according to the invention is virtually unlimited. The natural upper limit is determined more by the technical handling of the component (transport, etc.) than by the method. There is no minimum size for these components. The maximum thickness that can be realized is governed by the resin types used and the injection time available. This injection time is determined by economic, not technical restrictions. Other undesired side effects, such as, e.g., an exothermic reaction during hardening are dependent only on the resin system and not on the method.

To sum up, according to the invention, there is provided a method for producing fiber-reinforced plastic components of dry fiber composite semi-finished products by way of an injection method for injecting matrix material, in which a suctioning of air from the second cavity 27 occurs, through which a pressure drop from the first cavity 10 to the second cavity 27 results, and matrix material is suctioned from the reservoir into the evacuated first cavity 10, which matrix material due to the flow-promoting device 15 is distributed over the surface 11 of the semi-finished product 1 facing the membrane 7 and penetrates vertically into the semi-finished product 1. The linking of the functions distribution of the matrix material above the component surface through the flow-promoting device, and the areal ventilation method above the component and the flow-promoting device through the membrane film achieves the desired quality success with a hardening in a vacuum without overpressure.

1-26. (Canceled)

27. A method for producing a fiber-reinforced plastic component, the method comprising:
arranging a fiber composite semi-finished product on a tool;
forming a first cavity, wherein the first cavity is defined by at least one side of the fiber composite semi-finished product and a gas-permeable membrane which is impermeable to a matrix material;
forming a second cavity adjacent to the first cavity, wherein the second cavity is delimited from a surrounding area by a film that is gas-impermeable and matrix-material-impermeable and that is sealed with respect to the tool;
suctioning air from the second cavity, wherein the suctioning causes evacuation of the first cavity, such that the matrix material is suctioned from a reservoir into the first cavity;
during the suctioning, subjecting a flow of the matrix material into the first cavity to at least a temporary increase in pressure using a pressure control system;
distributing the matrix material over the at least one side using a flow promoting device; and
allowing the matrix material to penetrate into the fiber composite semi-finished product from a vertical direction.

28. The method of claim 27, wherein the fiber composite semi-finished product comprises a dry fiber composite semi-finished product and wherein the first cavity is formed around the at least one side of the fiber composite semi-finished product.

29. The method of claim 27, further comprising controlling a matrix material pressure based on at least one of a viscosity of the matrix material, a temperature of the matrix material, and a pressure in the first cavity.

30. The method of claim 27, further comprising controlling a pressure of the flow based on at least one of a viscosity of the matrix material, a temperature of the matrix material, and a pressure in the first cavity.

31. The method of claim 27, further comprising controlling a pressure of the flow based on a temperature of the matrix material flowing into the first cavity.

32. The method of claim 27, further comprising controlling a pressure of the flow based on a temperature in the first cavity.

33. A method for producing a fiber-reinforced plastic component, the method comprising:
arranging a fiber composite semi-finished product on a tool;
forming a first cavity, wherein the first cavity is defined by at least one side of the fiber composite semi-finished product and a gas-permeable membrane which is impermeable to a matrix material;
forming a second cavity adjacent to the first cavity, wherein the second cavity is delimited from a surrounding area by a film that is gas-impermeable and matrix-material-impermeable and that is sealed with respect to the tool;
suctioning air from the second cavity, wherein the suctioning causes evacuation of the first cavity, whereby the matrix material is suctioned from a reservoir into the first cavity via line;
during the suctioning, providing at least a temporary vacuum in the line using a pressure control system;
distributing the matrix material over the at least one side using a flow promoting device; and
allowing the matrix material to penetrate into the fiber composite semi-finished product from a vertical direction.

34. The method of claim 33, wherein the fiber composite semi-finished product comprises a dry fiber composite semi-finished product and wherein the first cavity is formed around the at least one side of the fiber composite semi-finished product.

35. A device for producing a fiber-reinforced plastic component by an injection process, the device comprising:
a tool adapted to support a fiber composite semi-finished product;
a first membrane which is gas-permeable and impermeable to a matrix material;
the first membrane being structured and arranged to form a first cavity with at least one side of the fiber composite semi-finished product;
a line allowing insertion of the matrix material into the first cavity;
a second membrane which is impermeable to gas and to the matrix material;
the second membrane being sealed with respect to the tool and being structured and arranged to form a second cavity adjacent to the first cavity;
the second cavity being delimited from a surrounding area via the second membrane; and
a pressure control system connected to the line and influencing a pressure in the line,
whereby, when air is suctioned from the second cavity, the first cavity is evacuated, the matrix material is suctioned from a reservoir into the first cavity, and the matrix material penetrates vertically into the fiber composite semi-finished product.

36. The device of claim 35, wherein the fiber composite semi-finished product comprises a dry fiber composite semi-finished product and wherein the first cavity is formed around the at least one side of the fiber composite semi-finished product.

37. A method for producing a fiber-reinforced plastic component, the method comprising:
arranging a fiber composite semi-finished product on a tool;
forming a first cavity, wherein the first cavity is defined by a gas-permeable membrane which is impermeable to a matrix material;
forming a second cavity adjacent to the first cavity, wherein the second cavity is delimited from a surrounding area by a film that is gas-impermeable and matrix-material-impermeable and that is sealed with respect to the tool;
suctioning air from the second cavity, wherein the suctioning causes evacuation of the first cavity and causes the matrix material to be suctioned from a reservoir into the first cavity;
distributing the matrix material over at least one side of the fiber composite semi-finished product using at least one flow promoting device arranged on the at least one side; and
allowing the matrix material to penetrate into the fiber composite semi-finished product from a vertical direction.

38. The method of claim 37, wherein the at least one side of the fiber composite semi-finished product faces the tool and wherein the first cavity is formed around the at least one side of the fiber composite semi-finished product.

39. The method of claim 37, wherein the at least one flow promoting device is arranged between the at least one side and the tool.

40. The method of claim 37, further comprising distributing the matrix material over an opposite side of the fiber composite semi-finished product using at least one other flow promoting device arranged on the opposite side.

41. The method of claim 37, further comprising, during the suctioning, subjecting a flow of the matrix material into the first cavity to at least a temporary increase in pressure using a pressure-producing system.

42. A device for producing a fiber-reinforced plastic component by an injection process, the device comprising:
a tool adapted to support a fiber composite semi-finished product;
at least one flow-promotion device configured to be arranged on a surface of the fiber composite semi-finished product which faces the tool;
a first membrane which is gas-permeable and impermeable to a matrix material;
the first membrane being structured and arranged to form a first cavity with at least one side of the fiber composite semi-finished product;
a line allowing insertion of the matrix material into the first cavity;
a second membrane which is impermeable to gas and to the matrix material; and
the second membrane being sealed with respect to the tool and being structured and arranged to form a second cavity adjacent to the first cavity,
whereby, when air is suctioned from the second cavity, the first cavity is evacuated, the matrix material is suctioned from a reservoir into the first cavity and into the at least one flow-promotion device, and the matrix material is distributed over the surface and penetrates vertically into the fiber composite semi-finished product.

43. The device of claim 42, wherein the fiber composite semi-finished product comprises a dry fiber composite semi-finished product and wherein the first cavity is formed around the at least one side of the fiber composite semi-finished product.

44. A method for producing a fiber-reinforced plastic component, the method comprising:
arranging a fiber composite semi-finished product on a tool;
applying a layer on at least one surface of the fiber composite semi-finished product on a tool, wherein the layer comprises one of a metallic layer and a composite layer;
forming a first cavity, wherein the first cavity is defined by a gas-permeable membrane which is impermeable to a matrix material;
forming a second cavity adjacent to the first cavity, wherein the second cavity is delimited from a surrounding area by a film that is gas-impermeable and matrix-material-impermeable and that is sealed with respect to the tool;
suctioning air from the second cavity, wherein the suctioning causes evacuation of the first cavity, such that the matrix material is suctioned from a reservoir into the first cavity; and
allowing the matrix material to penetration through the layer and into the fiber composite semi-finished product,
wherein the allowing connects the layer to the fiber composite semi-finished product.

45. The method of claim 44, wherein the first cavity is formed around the at least one side of the fiber composite semi-finished product.

46. The method of claim 44, wherein the allowing comprises allowing the matrix material to penetration through the layer and vertically into the fiber composite semi-finished product.

47. A device for producing a fiber-reinforced plastic component by an injection process, the device comprising:
a tool adapted to support a fiber composite semi-finished product;
at least one flow-promotion device configured to be arranged on at least one surface of the fiber composite semi-finished product;
a layer arranged on at least one surface of the fiber composite semi-finished product on a tool, wherein the layer comprises one of a metallic layer and a composite layer;
a membrane which is gas-permeable and impermeable to a matrix material;
the membrane being structured and arranged to form a first cavity with at least one side of the fiber composite semi-finished product;
a line allowing insertion of the matrix material into the first cavity;
a film which is impermeable to gas and to the matrix material; and
the film being sealed with respect to the tool and being structured and arranged to form a second cavity adjacent to the first cavity,
whereby, when air is suctioned from the second cavity, the first cavity is evacuated, the matrix material is suctioned from a reservoir into the first cavity, into the at least one flow-promotion device and through the layer, the matrix material penetrates vertically into the fiber composite semi-finished product, and the layer is connected to the fiber composite semi-finished product.

48. The device of claim 47, wherein the fiber composite semi-finished product comprises a dry fiber composite semi-finished product and wherein the first cavity is formed around the at least one side of the fiber composite semi-finished product.

49. The device of claim 47, wherein the at least one flow-promoting device is configured to cause a distribution of the matrix material over the at least one surface.

50. A method for producing a fiber-reinforced plastic component, the method comprising:
arranging a fiber composite semi-finished product on a tool;
forming a first cavity, wherein the first cavity is defined by a gas-permeable membrane which is impermeable to a matrix material;
forming a second cavity adjacent to the first cavity, wherein the second cavity is delimited from a surrounding area by a film that is gas-impermeable and matrix-material-impermeable and that is sealed with respect to the tool;
suctioning air from the second cavity, wherein the suctioning causes evacuation of the first cavity, such that the matrix material is suctioned from a reservoir into the first cavity; and
controlling vacuum, temperature and pressure of the first cavity in order to harden the fiber composite semi-finished product.
